(19) United States
(12) Patent Application Publication
(10) Pub. No.: US 2022/0023679 A1
(43) Pub. Date: Jan. 27, 2022

(54) Multipurpose Safety Mask

(71) Applicant: J&A Design Inc, WORCESTER, MA (US)

(72) Inventor: JONES KWADWO APPIAH, WORCESTER, MA (US)

(73) Assignee: JONES KWADWO APPIAH, WORCESTER, MA (US)

(21) Appl. No.: 17/443,150

(22) Filed: Jul. 21, 2021

Related U.S. Application Data
(60) Provisional application No. 62/705,937, filed on Jul. 23, 2020.

(51) Int. Cl. A62B 18/08; A41D 13/11; A62B 18/02

(52) U.S. Cl. CPC A62B 18/086; A62B 18/025; A41D 13/1146

(57) ABSTRACT

This invention in its current embodiment provides for the wearer a mask that allows the wearer to breath, speak clearly with easy and hydrate at will while wearing the mask. The design of the mask is of 4 parts that assemble to make the perfect safety mask. As shown in FIG. 8, the mask is assembled by connecting the straw and noise connector along with the straw and voice box together and then assembling them together with part 1 as shown on FIG. 8 (the nose and mouth cover housing) which then makes it possible to bond them with the face cover shield labelled item 2 on FIG. 8. When all part are assembled together, the face mask becomes functional by allowing all who wear the mask to talk with clarity, hydrate at will without talking the mask off and breath with comfort.

### CROSS REFERENCE TO RELATED APPLICATION

Provisional application No. 62/705,937, filed on Jul. 23, 2020 and entitled “SAFETY MASK”.

### BACKGROUND OF THE INVENTION

The invention herein relates to Face Mask, particularly to a Safety Face Mask. The Face Masks well known currently do not provide any provision for allowing the Individual/wearer to consume any liquid without removing the mask, therefore, fail to keep the individual/wearer safe in high risk polluted areas when hydration is needed. In addition, the existing Face mask do not allow the proper communication between individuals while wearing their mask.

A major setback of Face Mask in current use is its inability to prevent clouding and fogging on mask wearers glasses/spectacles. The wearer either must remove their glasses and clean them to have better vision or choose to remove their safety mask for better ventilation, vision, and unobstructed mouth aera for clear speech which subsequently leads to the wearer risking their health and life:

The Safety Mask advancement we are addresses in this application shall address all the issues identified above.

### BRIEF SUMMARY OF THE INVENTION

The present invention relates' generally to face mask and more particularly to safety mask for prevention of infectious respiratory diseases. The Safety Mask is a new product designed to cover a wears mouth and nose aera providing the wearer maximum protection to prevent direct transmission of infectious particles and dust in high risk as well as low-risk areas. In this invention, the Safety Mask described herein consists of noise and mouth cover housing, face cover shield, straw and voice box and straw and noise connector.

In an exemplary embodiment, the component of the device is made of suitable materials available within the times which are suitable in the process of melding and casting. These materials may be manufactured in their forming processes and assembled to create our Safety Mask illustrated and described in this filing.

The Safety Mask will provide the perfect solution for individuals looking for maximum protection while wearing their face mask and still maintaining the ability to hydrated, speak load and clear even in high-risk areas when taking off the safety mask is allowed or warranted.

The Safety Mask allows the wearer to speak clearly with an amplified voice. Connected to the straw whole mechanism is the voice box design to amplify the wearers voice. They join with the noise and mouth connector to work to provide protection to the wearer.

Due to the evolving climate and high pollutant air particles, a need has been identified to which the safety Mask has become the solution.

### BRIEF DESCRIPTION OF THE SEVERAL VIEWS OF THE DRAWING

The novel features of the invention are set forth. A better understanding of the features and advantages of the patent invention will be obtained by referencing the following detailed description set forth in this illustrative embodiment of our innovative safety mask enhancements:

FIG. 1 is a Bottom view of an exemplary embodiment of the present invention.

FIG. 2 is a left side view of an exemplary embodiment of the present invention.

FIG. 3 is a Front view side view of an exemplary embodiment of the present invention.

FIG. 4 is a right view of an exemplary embodiment of the present invention.

FIG. 5 is a bottom titled view of an exemplary embodiment of the present invention.

FIG. 6 is a right titled view of an exemplary embodiment of the present invention.

FIG. 7 is a front closure view of an exemplary embodiment of the present invention.

FIG. 8 is a sectional view of an exemplary embodiment of the present invention.

### DETAILED DESCRIPTION OF THE INVENTION

Provided herein is a face mask and more particularly an illustrative embodiment of our innovative safety mask enhancements designed specifically for wears of safety mask for the prevention of infectious respiratory diseases.

The Safety Mask described herein is adaptable for use in various industries not limiting to and only, health care, sanitation, food services, retails customer representatives and many other professions where interactions with customers and high-risk air purity spaces are required to perform duties. The design style of the mask and components allow the public to wear this mask on day to day movements moving from places to place without the fear of becoming infected with respiratory virus, bacteria and infections caused by saliva and other bodily fluids.

Basically, the Safety Mask represents a mouth and nose protection device that minimize the risk of direct transmission of infectious particles and dust.

The materials used in the Safety Mask are mouldable and castable compounds that provided maximum protection while making it breathable in combination with the nasal cavity design to pull the heat away from the face which always prevents fogging of a wearer's glasses. The Safety Mask completely covers the mouth and nose reducing the risk of inhaling any virus particles, bacteria and other particles that form to make the air in an aera pollutant.

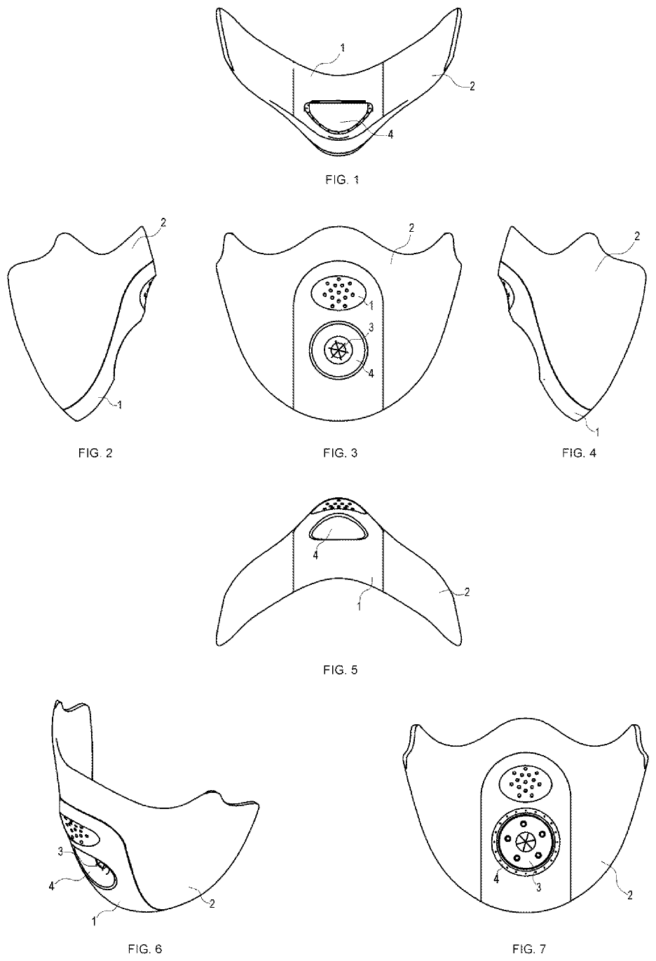

FIG. 1 is a Bottom view of an exemplary embodiment of the present invention comprising of Noise and Mouth Housing 1, Face Cover Shield 2, Straw and Noise Connector 4.

FIG. 2 is a left side view of an exemplary embodiment of the present invention comprising of Noise and Mouth Housing 1, Face Cover Shield 2.

FIG. 3 is a Front view side view of an exemplary embodiment of the present invention comprising of Noise and Mouth Housing 1, Face, Cover Shield 2, Straw and Voice Box 3, Straw and Noise Connector 4.

FIG. 4 is a right view of an exemplary embodiment of the present invention comprising of Noise and Mouth Housing 1, Face Cover Shield 2.

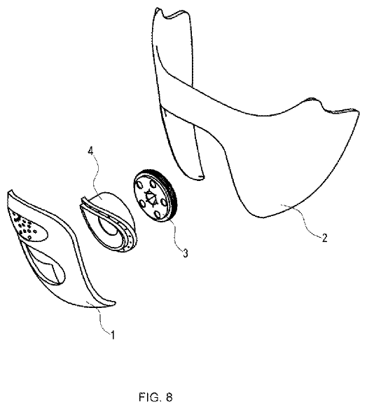

FIG. 5 is a bottom titled view of an exemplary embodiment of the present invention Noise and Mouth Housing 1, Face Cover Shield 2, Straw and Noise Connector 4.

FIG. 6 is a right titled view of an exemplary embodiment of the present invention comprising of Noise and Mouth Housing 1, Face Cover Shield 2, Straw and Voice Box 3, Straw and Noise Connector 4.

FIG. 7 is a front closure view of an exemplary embodiment of the present invention comprising of Face Cover Shield 2, Straw and Voice Box 3, Straw and Noise Connector 4.

FIG. 8 is a sectional view of an exemplary embodiment of the present invention comprising of Noise and Mouth Housing 1, Face Cover Shield 2, Straw and Voice Box 3, Straw and Noise Connector 4.

In an exemplary embodiment, the components of the Safety Mask may be made of any suitable materials by a suitable process. The Noise and Mouth Cover Housing of the Safety Mask is made of any material that can hold a moulded shape, Face Cover Shield is made of any material with formability, Straw and Voice Box is made of any material that can hold a moulded shape, Straw and Noise Connector is made of any material that can hold a moulded shape.

Although preferred embodiments of the invention have been shown and described herein, it is obvious to those skilled in the art that such embodiments are provided by way of example only.

Numerous variations, changes, and substitutions will occur as a result of this filing but to those skilled in the art, they will be able to identify without departing from this current invention that the variations are inspired by this filing and its components within. It should be understood that various alternatives to the embodiments of the invention described herein can be employed in practicing the inventions design shape and shape alone. It is intended that the following claims will define the scope of the invention and that the methods and structures within the scope of these claims and their equivalents be covered thereby.

When a feature is herein referred to as being “on” another feature, it can be directly on the other feature or intervening features may also be present. In contrast, when a feature is referred to as being “directly on” another feature, there are no intervening features present. It will also be understood that, when a feature is referred to as being “connected”, “attached” or “coupled” to another feature, it can be directly connected, attached or coupled to the other feature or intervening features may be present. In contract, when a feature is referred to as being “directly connected”, directly attached” or “directly coupled” to another feature, there are no intervening features present. Although described or shown with respect to one embodiment, the features so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing embodiments are not intended to be limiting of this invention. For example, as used herein, the singular forms “a”, “an” and “the” are intended to include the plural forms as well, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “P”.

Spatially relative terms, such as “under”, “below”, “lower”, “over”, “upper” and the like, may be used herein for ease of description to describe one element or feature's relationship to another element(s) or feature(s) as illustrated in figures. It will be understood that the spatially relative terms are intended to encompass different orientations of the device in use or operation in addition to the orientation depicted in the figures. For example, if a device in the figure is inverted, elements described as “under” or “beneath” other elements or features would then be oriented “over” the other elements or features. Thus, the exemplary term “under” can encompass both an orientation of over and under. The safety Mask may be otherwise oriented (rotated 90 degrees or at other orientations) and the spatially relative descriptors used herein interpreted accordingly. Similarly, the term “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element without departing from teachings of the present invention.

Throughout this specification and the claims which follow, unless context otherwise, the word “comprise”, and variations such as “comprises” and “comprising” means various components can be co jointly employed in the methods and articles. For example, the term “comprising” will be understood to imply the inclusion of any stated elements or steps but not the exclusion of any other elements or steps.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of the disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments of this mask and its component parts. Combinations of the above embodiments, and other embodiments not specifically described herein, will be apparent to those of skill in the art upon reviewing the above description.

1. A safety Mask comprising of multi parts:
a) Noise and Mouth Cover Housing Unit.
b) Straw and Voice Box amplifier
c) Straw and Noise Connector

2. Noise and Mouth cover housing unit, a component of the mask that allows the Straw hole and voice box amplifier to be attached to each other which subsequently attaches to the mask allowing the wearer to insert a straw and keep hydrated even in high risk areas.

3. Straw and Voice Box Amplifier, the voice box is made of mouldable material that allows the wearer to speak clearly with an amplified voice using technology of the time to create the sound amplification.
